(19) United States
(12) Patent Application Publication
(10) Pub. No.: US 2005/0286148 A1
(43) Pub. Date: Dec. 29, 2005

(54) Flexible mirror device for a vehicle

(76) Inventors: Yun Joo Lee, Torrance, CA (US); Jay Jong-Suk Kim, Torrance, CA (US); Yong Jong Kim, Los Angeles, CA (US); Young Ok Kim, Los Angeles, CA (US)

Correspondence Address: PARK & SUTTON LLP, 3255 WILSHIRE BLVD, SUITE 1110, LOS ANGELES, CA, 90010, US

(21) Appl. No.: 10/876,347

(22) Filed: Jun. 25, 2004

(51) Int. Cl. G02B 17/00

(52) U.S. Cl. 359/879; 359/871

(57) ABSTRACT

A mirror device for a vehicle comprising a base detachably attached to an internal portion of the vehicle, within a viewable range from a driver sitting behind a steering wheel of the vehicle, a mirror attached to a mirror pad, and a substantially elongate member connecting the mirror pad to the base. The elongate member is formed of belt rings and miniature dumbbells alternately interlinked with the belt rings such that each ball of the dumbbells is rotatably caught in a corresponding one of the belt rings, whereby the elongate member is controllably adjustable to one of an infinite number of aerial settings thereof so that the mirror is subsequently displaced to an aerial position desired by the driver.

### BACKGROUND OF THE INVENTION

The present invention relates to a mirror device for a safe driving of a vehicle. More particularly, the present invention relates to a mirror device for a vehicle, enabling a vehicle driver to conveniently see through the so-called dead zone while improving a rearview visibility of the driver.

As is well known, vehicle drivers rely on side mirrors and rearview mirrors to change lanes on the road, to secure driving safety, to effectuate defensive driving and to prevent other hazardous incidents open to all the vehicle drivers day in and day out. The side mirrors are preferred by most drivers when changing lanes and making turns. In order to secure safe driving and decrease road incidents, what is strongly recommended by governmental vehicle departments is a regulation that commands a driver look over the shoulder to check clearance of the lane to which the driver wants to move. However, limitations are experienced among drivers who are too short to look over the headrest of the driver's seat and among senior citizens whose physical slowness may trigger mishaps on the road.

Supplemental mirrors have been long introduced on the market like a miniature convex mirror attached on the side mirror. However, a demand on the market is a mirror device that aids relatively short persons and senior citizens to sit behind the wheel and drive in more secured safety.

### SUMMARY OF THE INVENTION

The present invention is contrived to overcome the conventional disadvantages. Accordingly, it is an objective of the present invention to provide a flexible, detachable and portable mirror device for a vehicle. Another objective is to provide a mirror device for a vehicle that enables a driver to change lanes and make turns with clearer visibility of rear views. A further objective is to enable a senior citizen and a relatively short person to make a reliable and safe driving.

To achieve these and other objectives, the mirror device for a vehicle according to the present invention comprises a base detachably attached to an internal portion of the vehicle where the internal portion is within a viewable range from a driver sitting behind a steering wheel of the vehicle, a mirror attached to a mirror pad, and a substantially elongate member connecting the mirror pad to the base. The elongate member is formed of belt rings and miniature dumbbells alternately interlinked with the belt rings such that each ball of the dumbbells is rotatably caught in a corresponding one of the belt rings, whereby the elongate member is controllably adjustable to one of an infinite number of aerial settings thereof so that the mirror is subsequently displaced to an aerial position desired by the driver.

For a better performance, the internal portion may be a driver's window glass of the vehicle or a windshield of the vehicle. The mirror is formed of a convex glass lens, and the base comprises a plastic suction cup.

In an embodiment, the base may be a clamp detachably attached to an internal portion of the vehicle. The clamp has first and second wings mutually engaged by an elastic member between the wings, wherein the clamp wings each have upper and lower ends. The elastic member enables the clamp wing lower ends to remain elastically attached to each other when in idle and become elastically detached from each other when the clamp wing upper ends are manually pressed toward each other. In this construction, the substantially elongate member is provided to connect the mirror pad to the first wing upper end of the clamp. The internal portion may be either a dashboard adjacent to the steering wheel of the vehicle or a ventilation port louver adjacent to the steering wheel of the vehicle. Selectively, the internal portion may be adjacent to a ventilation port in the vehicle. The clamp may be formed of a plastic material and the elastic member may be a metallic clip.

Advantages of the present invention are numerous in that: (1) the elongate member secures controllable adjustability of the mirror device so that the mirror can be controllably adjusted to an aerial position depending on safety degree or terrain of the driving area, thereby maximizing usability and product reliability; (2) the detachable attachment mechanism of the base or the clamp of the mirror device enables a driver to easily reposition the mirror device, for example, from a side window to the dashboard or to a ventilation port louver, within the vehicle, thereby enhancing instant availability and subsequent user's satisfaction; and (3) the combination of the belt rings and the miniature dumbbells is elevated to flexibility and portability of the mirror device and further elevated to driving safety and subsequent marketability.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a view showing construction and installation of a mirror device for a vehicle according to a preferred embodiment of the present invention;

FIG. 2 is a view showing formation of the vehicle mirror device according to the present invention;

FIG. 3 is a cross-sectional view taken along line III-III in FIG. 2;

FIG. 4 is a cross-sectional view taken along line IV-IV in FIG. 2;

FIGS. 5 and 6 are installation views each showing detachable attachment of the mirror device for a vehicle according to the present invention; and

FIG. 7 is a view showing another embodiment according to the present invention.

### DETAILED DESCRIPTION OF THE PREFERRED EMBODIMENTS

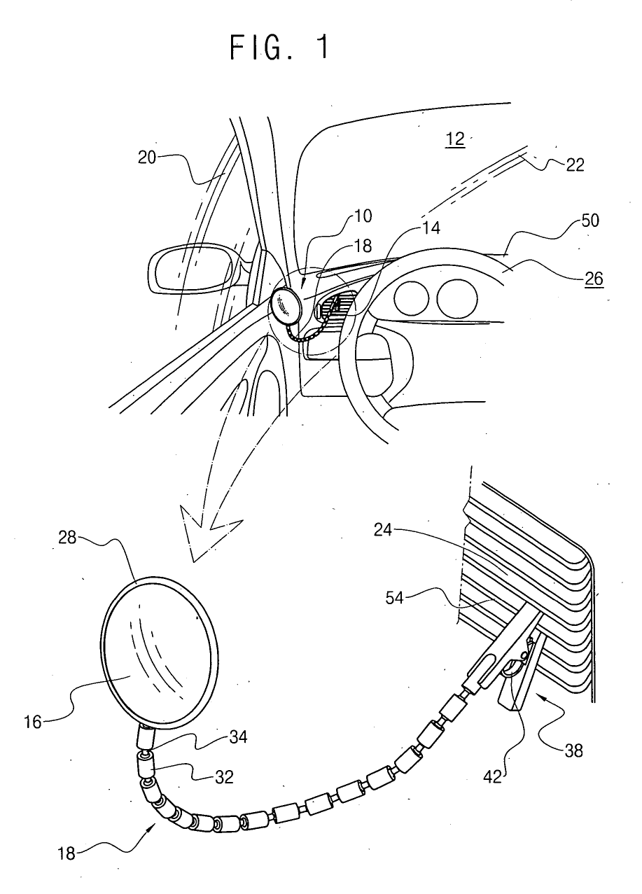

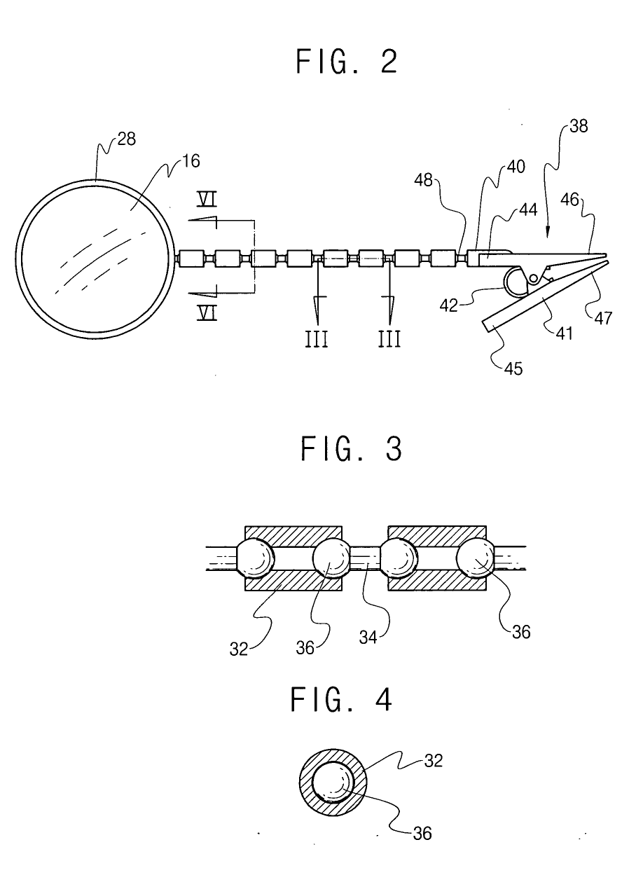

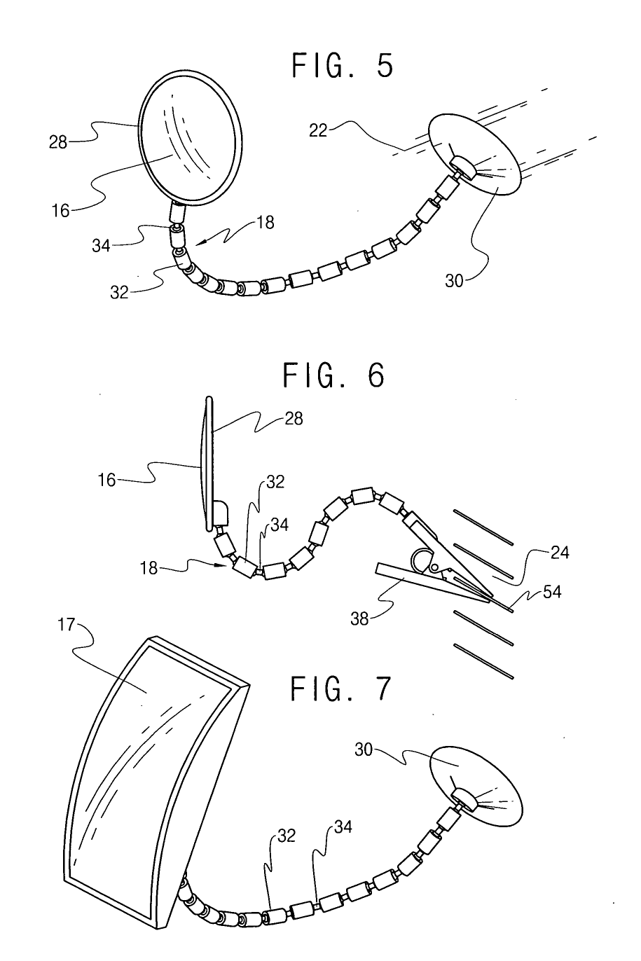

FIGS. 1 to 4 each show construction and installation according to a preferred embodiment of a mirror device 10 for a vehicle 12. FIGS. 5 and 6 each show specific application of the mirror device 10 within the vehicle 12. FIG. 7 shows a mirror device for a vehicle according to another embodiment of the vehicle mirror device 10. Here, the vehicle 12 denotes, but not limited to, a land vehicle with internal combustion engines.

As shown therein, the vehicle mirror device 10 comprises a base 14, a mirror 16 and a substantially elongate member 18. The base 14 is detachably attached to an internal portion 20, 22, 24 of the vehicle. Preferably, the internal portion 20, 22, 24 is provided within a viewable range from a driver (not shown) sitting behind a steering wheel 26 of the vehicle 12. It is recommended that the mirror 16 be attached to a mirror pad 28.

In order to facilitate the detachable attachment of the mirror device 10 within the vehicle 12, the base 14 may be incorporated in a plastic suction cup 30 as shown FIG. 5 where the plastic suction cup 30 serving as the base 14 is detachably vacuum-attached to a driver's window glass 20 being the internal portion within the vehicle 12.

The plastic suction cup 30 may be alternately attached to a windshield 22 also serving as the internal portion of the vehicle 12. Meanwhile, the mirror 16 is preferably formed of a convex glass lens to further improve the viewable range compared to a flat glass mirror. Selectively, the mirror 16 may be formed of an arc-waved glass lens 17 as shown in FIG. 7.

To improve flexibility of the vehicle mirror device 10, the substantially elongate member 18 is formed such that the elongate member 18 connects the mirror pad 28 to the base 14. In a preferred version, the elongate member 18 is formed of belt rings 32 and miniature dumbbells 34 where the miniature dumbbells 34 are alternately interlinked with the belt rings 32 such that each ball 36 of the dumbbells 34 is rotatably caught in a corresponding one of the belt rings 32, whereby the elongate member 18 becomes controllably adjustable to one of an infinite number of aerial settings thereof so that the mirror 16 is subsequently displaced to an aerial position desired by the driver.

For a better performance, the base 14 may be formed of a clamp 38. The clamp 38 is formed such that the clamp 38 is detachably attached to a selected one of the internal portion 24, for example, a ventilation port of the vehicle 12. The clamp 38 has first and second wings 40, 41 mutually engaged by an elastic member 42 between the wings 40, 41. Here, the clamp wings 40, 41 each have upper and lower ends 44, 45, 46, 47. The clamp 38 is preferably formed of a plastic material. In a desired mode, the elastic member 42 is one selected from a metallic clip and a tension spring.

Meanwhile, the elastic member 42 enables the clamp wing lower ends 46, 47 to remain elastically attached to each other when in idle and become elastically detached from each other when the clamp wing upper ends 44, 45 are manually pressed toward each other. In this mechanism, it is preferred that the substantially elongate member 18 connecting the mirror pad 28 to the first wing upper end 44 of the clamp 38. Specifically, the upper end 44 of the first wing 40 of the clamp 38 has a ball 48 identical to one of the plurality of balls 36 of the miniature dumbbells 34 so that the lowest one of the belt rings 32 receives the ball 48 extending from the first wing upper end 44.

When the clamp 38 serves as the base 14, a dashboard 50 adjacent to the steering wheel 26 of the vehicle 12 may be the internal portion within the vehicle 12. In this formation, the internal portion serving as the dashboard 50 is preferably located adjacent to the ventilation port 24 in the vehicle 12. Selectively, the internal portion may be a ventilation port louver 54 adjacent to the steering wheel 26 of the vehicle 12. Here, the ventilation port 24 releases therethrough warm or cool air and the port louver 54 serves to control the amount of the warm or cool air coming out of the ventilation port 24.

As discussed above, the vehicle mirror device 10 is advantageous in that the elongate member 18 secures controllable adjustability of the mirror device 10 so that the mirror 16 can be controllably adjusted to an aerial position depending on safety degree or terrain of the driving area, thereby maximizing usability and product reliability. Further, the detachable attachment mechanism of the base 14 or the clamp 38 of the mirror device 10 enables a driver to easily reposition the mirror device 10, for example, from the side window glass 20 to the dashboard 50 or to a ventilation port louver 54, within the vehicle 12, thereby enhancing instant availability and subsequent user's satisfaction.

In addition, the combination of the belt rings 32 and the miniature dumbbells 34 is elevated to flexibility and portability of the mirror device 10 and further elevated to driving safety and subsequent marketability.

Although the invention has been described in considerable detail with reference to certain preferred versions thereof, other versions are possible by converting the aforementioned construction. Therefore, the scope of the invention shall not be limited by the specification specified above and the appended claims.

1. A mirror device for a vehicle, comprising:
a) a base detachably attached to an internal portion of the vehicle, wherein the internal portion is within a viewable range from a driver sitting behind a steering wheel of the vehicle;
b) a mirror attached to a mirror pad; and
c) a substantially elongate member connecting the mirror pad to the base, wherein the elongate member is controllably adjustable to one of an infinite number of aerial settings thereof so that the mirror is subsequently displaced to an aerial position desired by the driver.

2. The mirror device of claim 1 wherein the internal portion is a driver's window glass of the vehicle.

3. The mirror device of claim 1 wherein the internal portion is a windshield of the vehicle.

4. The mirror device of claim 1 wherein the mirror is formed of a convex glass lens.

5. The mirror device of claim 1 wherein the mirror is formed of an arc-waved glass lens.

6. The mirror device of claim 1 wherein the base comprises a plastic suction cup.

7. A mirror device for a vehicle, comprising:
a) a base detachably attached to an internal portion of the vehicle, wherein the internal portion is within a viewable range from a driver sitting behind a steering wheel of the vehicle;
b) a mirror attached to a mirror pad; and
c) a substantially elongate member connecting the mirror pad to the base, wherein the elongate member is formed of belt rings and miniature dumbbells alternately interlinked with the belt rings such that each ball of the dumbbells is rotatably caught in a corresponding one of the belt rings, whereby the elongate member is controllably adjustable to one of an infinite number of aerial settings thereof so that the mirror is subsequently displaced to an aerial position desired by the driver.

8. The mirror device of claim 7 wherein the internal portion is a driver's window glass of the vehicle.

9. The mirror device of claim 7 wherein the internal portion is a windshield of the vehicle.

10. The mirror device of claim 7 wherein the mirror is formed of a convex glass lens.

11. The mirror device of claim 7 wherein the mirror is formed of an arc-waved glass lens.

12. The mirror device of claim 7 wherein the base comprises a plastic suction cup.

13. A mirror device for a vehicle, comprising:
a) a base being a clamp detachably attached to an internal portion of the vehicle, wherein the clamp has first and second wings mutually engaged by an elastic member between the wings, wherein the clamp wings each have upper and lower ends, wherein the elastic member enables the clamp wing lower ends to remain elastically attached to each other when in idle and become elastically detached from each other when the clamp wing upper ends are manually pressed toward each other, wherein the internal portion is within a viewable range from a driver sitting behind a steering wheel of the vehicle;
b) a mirror attached to a mirror pad; and
c) a substantially elongate member connecting the mirror pad to the first wing upper end of the clamp, wherein the elongate member is formed of belt rings and miniature dumbbells alternately interlinked with the belt rings such that each ball of the dumbbells is rotatably caught in a corresponding one of the belt rings, whereby the elongate member is controllably adjustable to one of an infinite number of aerial settings thereof so that the mirror is subsequently displaced to an aerial position desired by the driver.

14. The mirror device of claim 13 wherein the internal portion is a dashboard adjacent to the steering wheel of the vehicle.

15. The mirror device of claim 13 wherein the internal portion is adjacent to a ventilation port in the vehicle.

16. The mirror device of claim 13 wherein the internal portion is a ventilation port louver adjacent to the steering wheel of the vehicle.

17. The mirror device of claim 13 wherein the mirror is formed of a convex glass lens.

18. The mirror device of claim 13 wherein the mirror is formed of an arc-waved glass lens.

19. The mirror device of claim 13 wherein the clamp is formed of a plastic material.

20. The mirror device of claim 13 wherein the elastic member is a metallic clip.
